(19) United States
(12) Patent Application Publication
(10) Pub. No.: US 2018/0291302 A1
(43) Pub. Date: Oct. 11, 2018

(54) Ionic Liquid, Lubricant, and Magnetic Recording Medium

(71) Applicant: Dexerials Corporation, Tokyo (JP)

(72) Inventors: Hirofumi Kondo, Tokyo (JP); Kouki Hatsuda, Tokyo (JP); Nobuo Tano, Tokyo (JP); Pankaj Baghel, Tokyo (JP)

(21) Appl. No.: 15/945,439

(22) Filed: Apr. 4, 2018

(30) Foreign Application Priority Data
Apr. 7, 2017 (JP) 2017-076878

(51) Int. Cl. C10M 133/06; C10M 139/00; G11B 5/725

(52) U.S. Cl. CPC C10M 133/06; C10M 139/00; C10N 2240/204; C10M 2215/04; C10M 2227/061; G11B 5/725

(57) ABSTRACT

A lubricant including an ionic liquid wherein the ionic liquid includes a cation that is represented by General Formula (A) below and is free from a fluorine atom, and an anion that is represented by General Formula (X) below and is free from a fluorine atom,

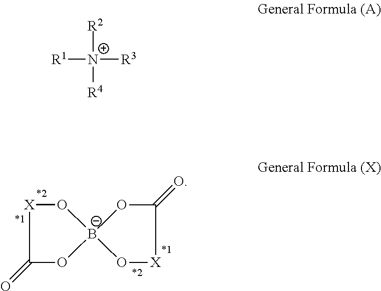

### CROSS-REFERENCE TO RELATED APPLICATIONS

The present application claims priority under 35 U.S.C. § 119 to Japanese Patent Application No. 2017-076878 filed Apr. 7, 2017. The contents of which are incorporated herein by reference in their entirety.

### BACKGROUND OF THE INVENTION

### Field of the Invention

The present invention relates to an ionic liquid, a lubricant including the ionic liquid, and a magnetic recording medium using the lubricant.

### Description of the Related Art

Conventionally, in a thin film magnetic recording medium, a lubricant is applied onto a surface of a magnetic layer for the purpose of reducing frictions between a magnetic head and the surface of the magnetic recording medium, or reducing abrasion. In order to avoid adhesion, such as sticktion, an actual film thickness of the lubricant is of a molecular order. Accordingly, it is not exaggeration to say that the most important thing for a thin film magnetic recording medium is to select a lubricant giving excellent abrasion resistance in any environment.

During a life of a magnetic recording medium, it is important that a lubricant is present on a surface of the medium without causing desorption, spin-off, and chemical deteriorations. Making the lubricant present on a surface of a medium is more difficult, as the surface of the thin film magnetic recording medium is smoother. This is because the thin film magnetic recording medium does not have an ability of replenishing a lubricant as with a coating-type magnetic recording medium.

An excess amount of the lubricant on the surface becomes the mobile lubricant, and therefore a function of replenishing the lost lubricant can be provided. However, a problem associated with adhesion is caused, and in a crucial case, sticktion is caused, which is a factor of driving failures.

As illustrated in FIG. 1, moreover, an increase rate of an areal density of a hard disk drive of a product has been decreased in the last several years in a non-patent literature (Advances in Tribology, Volume 2013, Article ID 521086), but the year rate of 25% has been achieved. The areal density is nearly reaching 4 Tb/in², which is one of the targets. It can be found that a distance of a head-disk interface relative to an increase of the recording density has been reduced as illustrated in FIG. 2. There is always a need for improving reliability with the decrease in the head-disk interface distance, which has been described in non-patent literatures (C. M. Mate, Q. Dai, R. N. Payne, B. E. Knigge, and P. Baumgart, “Will the numbers add up for sub-7-nm magnetic spacings? Future metrology issues for disk drive lubricants, overcoats, and topographies,” IEEE Transactions on Magnetics, vol. 41, no. 2, pp. 626-631, 2005, B. Marchon and T. Olson, “Magnetic spacing trends: from LMR to PMR and beyond,” IEEE Transactions on Magnetics, vol. 45, no. 10, pp. 3608-3611, 2009, and J. Gui, “Tribology challenges for head-disk interface toward 1 Tb/in²,” IEEE Transactions on Magnetics, vol. 39, no. 2, pp. 716-721, 2003).

A current recording density is about 1 Tb/in², spacing is about 6 nm, a thickness of a lubricant is about 0.8 nm, and the thickness of the lubricant needs to be reduced for a future recording density of 4 Tb/in². A molecular weight of a conventional PFPE lubricant needs to be made small in order to reduce a film thickness of the lubricant, but thermal stability may be deteriorated when the molecular weight is small. It can be understood that the problems in reliability cannot be sufficiently solved with a conventional perfluoropolyether (PFPE)-based lubricant.

Particularly for a thin film magnetic recording medium having high surface smoothness, a novel lubricant is designed at a molecular level, and synthesized to solve the above-described trade-off. Moreover, there are numbers of reports regarding lubricity of PFPE. As described, lubricants are very important in magnetic recording media.

Chemical structures of typical PFPE-based lubricants are depicted in Table 1.

TABLE 1
Fomblin-based lubricants

| | |
|---|---|
| | X—CF₂(OCF₂CF₂)ₙ(OCF₂)ₘOCF₂—X(0.5 < n/m < 1) |
| Z | X = —OCF₃ |
| Z-DOL | X = —CH₂OH |
| Z-DIAC | X = —COOH |
| Z-Tetraol | 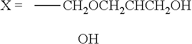 |
| AM2001 | 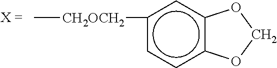 |

Other lubricants

| | |
|---|---|
| A20H | 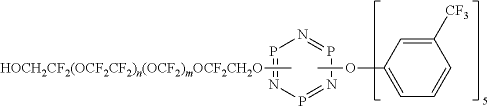 |
| Mono | F—(CF₂CF₂CF₂O)₁—CF₂CF₂CH₂—N(C₃H₇)₂ |

Z-DOL in Table 1 is one of lubricants typically used for thin-film magnetic recording media. Moreover, Z-Tetraol (ZTMD) is a lubricant, in which a functional hydroxyl group is further introduced into a main chain of PFPE, and it has been reported that use of Z-Tetraol enhances reliability of a drive while reducing a space at an interface between a head and a medium. It has been reported that A20H suppresses decomposition of the PFPE main chain with Lewis acid or Lewis base, and improves tribological properties. On the other hand, it has been reported that Mono has a different polymer main chain and different polar groups to those of the PFPE, the polymer main chain and polar groups of Mono are respectively poly-n-propyloxy, and amine, and Mono reduces adhesion interactions at near contact.

However, a typical solid lubricant, which has a high melting point and is considered thermally stable, disturbs an electromagnetic conversion process that is extremely highly sensitive, and moreover, an abrasion powder scraped by a head is generated on a running track. Therefore, abrasion properties are deteriorated. As described above, the liquid lubricant has mobility that enables to move the adjacent lubricant layer to replenish the lubricant removed due to abrasion by the head. However, the lubricant is span-off from a surface of the disk especially at a high temperature during driving of the disk, because of the mobility of the lubricant, and thus the lubricant is reduced. As a result, a protection function is lost. Accordingly, a lubricant having a high viscosity and low volatility is suitably used, and use of such a lubricant enables to prolong a service life of a disk drive with suppressing an evaporation rate.

Meanwhile, the limit of a surface recording density of a hard disk is said to be from 1 Tb/in² to 2.5 Tb/in². Currently, the surface recording density is getting close to the limit, but developments of technology for increasing capacities have been actively conducted with a reduction in particle size of magnetic particles as a premise. As the technology for increasing capacities, there are a reduction in an effective flying height and introduction of Shingle Write (BMP).

Moreover, there is “thermally-assisted magnetic recording (heat assisted magnetic recording)” as the next-generation recording technology. The outline of the thermally-assisted magnetic recording is illustrated in FIG. 3. In FIG. 3, the reference number 1 is laser light, the reference number 2 is near field light, the reference number 3 is a recording head (PMR element), and the reference number 4 is a reproducing head (TMR element). The problems of the thermally-assisted magnetic recording include a deterioration of durability due to evaporation or deterioration of a lubricant on a surface of a magnetic layer because a recording area is heated by laser during recording and reproducing. Even though it is a short period, there is a possibility that a thin film magnetic recording medium is exposed to a high temperature, which is 400° C. or higher, in thermally-assisted magnetic recording. Therefore, there are concerns about thermal stability of a lubricant generally used for thin film magnetic recording media, such as Z-DOL and Z-TETRAOL.

Considering the above-described lubricating systems, requirements for a low-friction and low-abrasion lubricant used for thin film magnetic recording media are as follows.

(1) Low volatility.
(2) Low surface tension for a surface filling function.
(3) Interaction between terminal polar groups and a surface of a disk.
(4) High thermal and oxidization stability in order to avoid decomposition or reduction over a service period.
(5) Chemically inactive with metals, glass, and polymers, and no abrasion powder generated by a head or a guide.
(6) No toxicity and no flammability.
(7) Excellent boundary lubricating properties.
(8) Soluble with organic solvents, particularly fluorine-based solvents.

Recently, an ionic liquid has been attracted attentions as one of solvents for synthesis of organic or inorganic materials and being friendly to the environments in the fields of electricity storage materials, a separation technology, and a catalyst technology. The ionic liquid is roughly classified as a molten salt having a low melting point. The ionic liquid is typically a molten salt having a melting point of 100° C. or lower, among the above-mentioned molten salts. The important properties of the ionic liquid used as a lubricant are low volatility, inflammability, thermal stability, and an excellent dissolving performance.

For example, abrasion and wear of a surface of a metal or ceramic may be reduced by using a certain ionic liquid compared to a conventional hydrocarbon-based lubricant. For example, there is a report that, in the case where a fluoroalkyl group-substituted imidazole cation-based ionic liquid is synthesized, and tetrafluoroboric acid salt or hexafluorophosphoric acid salt of alkyl imidazolium is used for steel, aluminium, copper, single crystal SiO₂, silicon, or sialon ceramics (Si—Al—O—N), tribological properties more excellent than those of cyclic phosphazene (X-1P) or PFPE are exhibited. Moreover, there is a report that an ammonium-based ionic liquid reduces frictions more than a base oil in the region of elastohydrodynamic to boundary lubrication. Moreover, effects of the ionic liquid as an additive for a base oil have been studied, and a chemical or tribochemical reaction of the ionic liquid has been researched to understand lubricating systems. However, there are almost no application examples of the ionic liquid to magnetic recording media that require lubricity properties at a molecular level.

In case of an ionic liquid, a combination of a cation and an anion largely influences on physical or chemical characteristics of the ionic liquid. A variety of the anion site is many, but the relationship could not be clarified unless the cation is a cation structurally similar to the anion (see, for example, Dzyuba, S. V.; Bartsch, R. A., “Influence of Structural Variations in 1-Alkyl(aralkyl)-3-Methylimidazolium Hexafluorophosphates and Bis(trifluoromethylsulfonyl)imides on Physical Properties of the Ionic Liquids, Chem. Phys. Phys. Chem. 2002, 3, 161-166). For example, viscosity of the liquid increases, as hydrogen bonding strength of halogen is stronger (Cl>Br>I). However, the method for increasing the viscosity is not limited to the increase in the hydrogen bonding strength. For example, the viscosity can be increased by varying an alkyl chain of imidazole. Similarly, the combination of the anion and cation influences on a melting point, surface tension, and thermal stability, but a wide range of researches has not be conducted on an influence of the molecular structure. Specifically, it is possible to change physical or chemical characteristics of an ionic liquid by with a combination of cations or anions, but it is difficult to predict as described in non-patent literatures (Anderson, J. L., Ding R., Ellern A., Armstrong D. W., “Structure and Properties of High Stability Geminal Dicationic Ionic Liquids”, J. Am. Chem. Soc., 2005, 127, 593-604).

Currently, several thousands of ionic liquids composed of various combinations of extensively known cations and anions are disclosed in literatures and patent publications. For use in a lubricant, an ionic liquid including imidazolium, pyrrolidinium, pyridinium, ammonium, phosphonium etc. as a cation, and tetrafluoroborate, hexafluorophosphate, bis(perfluorosulfonyl)imide, or perfluorosulfonium as an anion has been most commonly studied. As a base oil, alkyl imidazolium tetrafluoroborate and hexafluorophosphate exhibit promising lubricating properties. However, some of ionic liquids having a fluorine atom in a structure thereof have extremely high reactivity, and have a high risk of tribocorrosion when the ionic liquids are brought into contact with ferrous and non-ferrous metals.

It has been disclosed that a tetrafluoroborate anion [BF₄]-based ionic liquid including boron gives excellent results in tribological properties with various-ferrous and non-ferrous metal systems (see Ye, C., Liu, W., Chen, Y., Yu, L.: Room-temperature ionic liquids: a novel versatile lubricant. Chem. Commun. 2244-2245 (2001)). In Japanese Patent Application Laid-Open (JP-A) No. 2012-518702, moreover, it is disclosed that friction and abrasion of an internal combustion engine can be reduced by adding a tetrafluoroborate anion-based ionic liquid to a composition of lubrication oil.

Moreover, Zhang et al. have reported that an ionic liquid including a BF₄⁻ anion has more excellent tribological properties than an ionic liquid including NT_{f2}⁻ or N(CN)₂⁻ anion at the contact between steel and steel and the contact between steel and aluminium (see Q. Zhang, Z. Li, J. Zhang, S. Zhang, L. Zhu, J. Yang, X. Zhang, Y. J. Deng. Physicochemical properties of nitrile-functionalized ionic liquids. J. Phys. Chem. B, 2007, 111, 2864-2872). The reason why the BE₄⁻ anion exhibits excellent tribological properties is because boron reacts at an interface with extreme pressure to form a lubricating film in an environment of high pressure and a high temperature and therefore excellent tribological properties are exhibited.

However, use of an ionic liquid including [BF₄⁻] is not desirable in tribology and other industrial applications because of reactivity of [BF₄⁻] against moisture. Specifically, [BF₄⁻] causes hydrolysis to thereby generate hydrogen fluoride. The generated hydrogen fluoride causes corrosion as a result of various tribochemical reactions, and eventually a substrate in a mechanical system may be damaged. In addition, a fluorine-containing ionic liquid may release toxic and corrosive hydrogen fluoride to a surrounding environment. Accordingly, efforts have been made to design and synthesize a boron-based ionic liquid that has high stability against hydrolysis and is free from fluorine. Therefore, there is a strong need for developments of a novel ionic liquid that is hydrophobic and includes an anion free from fluorine.

Meanwhile, developed are ionic liquids including borate-based anions, such as a mandelate borate anion, a salicylate borate anion, an oxalate borate anion, a malonate borate anion, a succinate borate anion, a glutarate borate anion, and an adipate borate anion (see Phys. Chem. Chem. Phys., 2011, vol. 13, pp. 12865, and Japanese Patent No. 5920900). The developed ionic liquids exhibit excellent lubrication properties in combination with a cation, such as a tetraalkyl phosphonium cation, a pyrrolidinium cation, an imidazolium cation, and choline.

Under the situation that ionic liquids are expected to be used for lubricants for use in various applications, ionic liquids having more excellent anti-friction properties than the proposed ionic liquids above are desired.

### SUMMARY OF THE INVENTION

The present invention has been proposed with considering the above-described situations in the art and aims to provide an ionic liquid free from fluorine and having excellent anti-friction properties, a lubricant using the ionic liquid, and a magnetic recording medium having excellent practical properties.

Means for solving the above-described problems are as follows.

<1> A lubricant including:

an ionic liquid,

wherein the ionic liquid includes a cation that is represented by General Formula (A) below and is free from a fluorine atom, and an anion that is represented by General Formula (X) below and is free from a fluorine atom,

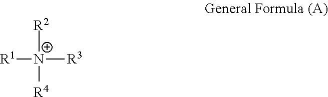

where, in General Formula (A), R¹ is a group including a straight-chain hydrocarbon group having 6 or more carbon atoms, and R², R³, and R⁴ are each independently a hydrogen atom or a hydrocarbon group,

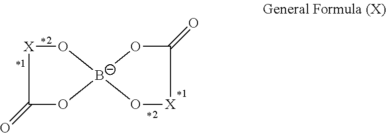

where, in General Formula (X), X is represented by General Formula (Y-1) below, General Formula (Y-2) below, or General Formula (Y-3) below,

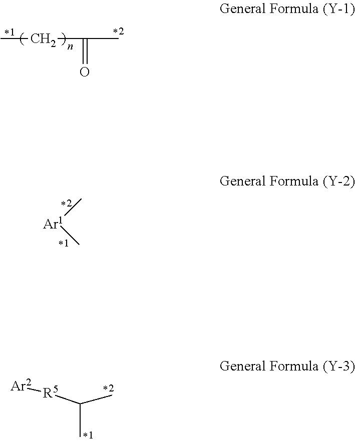

where, General Formula (Y-1), n is an integer of from 0 to 5,
where, General Formula (Y-2), Ar¹ is an aromatic group that has bond *1 and bond *2 at a meta position and may have a substituent, and
where, in General Formula (Y-3), R⁵ is a bond or an alkylene group and Are is an aromatic group that may have a substituent.
<2> The lubricant according to <1>,
wherein in General Formula (A), one of R², R³, and R⁴ is a hydrogen atom.
<3> The lubricant according to <1> or <2>,
wherein General Formula (X) is any one of structural formulae below,

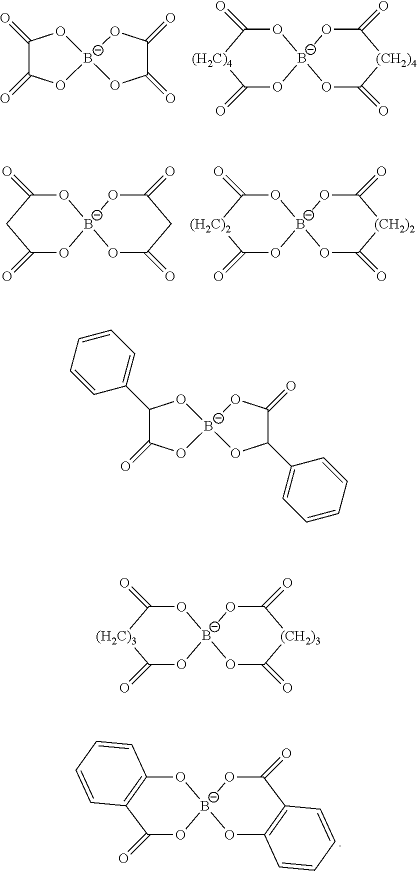

<4> A magnetic recording medium including:

a non-magnetic support;

a magnetic layer disposed on the non-magnetic support; and

the lubricant according to any one of <1> to <3> disposed on the magnetic layer.

<5> An ionic liquid including:

a cation that is represented by General Formula (A) below and is free from a fluorine atom; and

an anion that is represented by General Formula (X) below and is free from a fluorine atom,

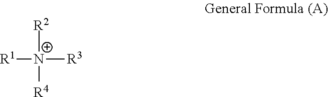

where, in General Formula (A), R¹ is a group including a straight-chain hydrocarbon group having 6 or more carbon atoms, and R², R³, and R⁴ are each independently a hydrogen atom or a hydrocarbon group,

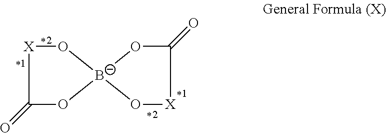

where, in General Formula (X), X is represented by General Formula (Y-1) below, General Formula (Y-2) below, or General Formula (Y-3) below,

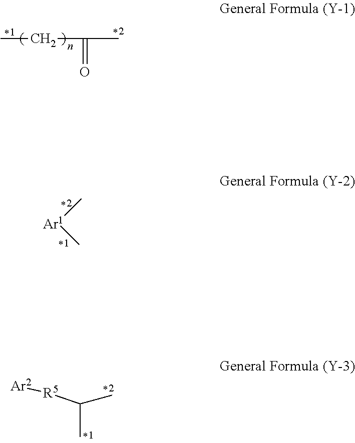

where, General Formula (Y-1), n is an integer of from 0 to 5,
where, General Formula (Y-2), A^{r1} is an aromatic group that has bond *1 and bond *2 at a meta position and may have a substituent, and
where, in General Formula (Y-3), R⁵ is a bond or an alkylene group and Are is an aromatic group that may have a substituent.
<6> The ionic liquid according to <5>,
wherein in General Formula (A), one of R², R³, and R⁴ is a hydrogen atom.
<7> The ionic liquid according to <5> or <6>,
wherein General Formula (X) is any one of structural formulae below,

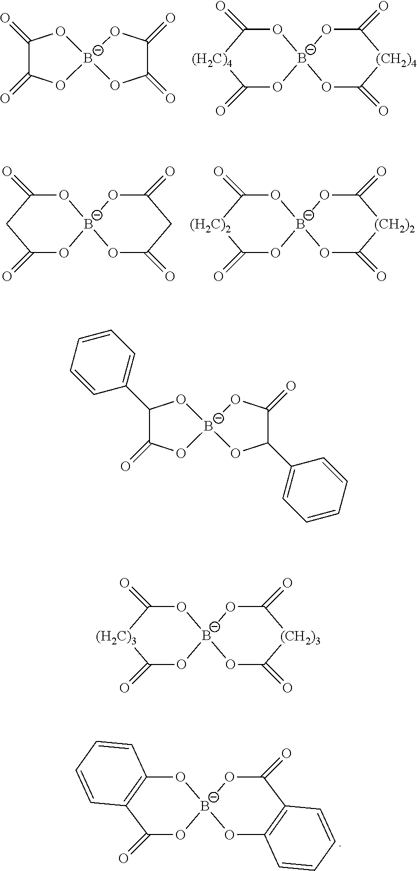

The present invention can provide an ionic liquid free from fluorine and having excellent anti-friction properties, a lubricant using the ionic liquid, and a magnetic recording medium having excellent practical properties.

### BRIEF DESCRIPTION OF THE DRAWINGS

FIG. 1 is a graph depicting transition and prediction of an areal recording density of a hard disk drive.

FIG. 2 is a roadmap of head-medium spacing relative to an areal recording density of a hard disk.

FIG. 3 is a schematic view illustrating thermally-assisted magnetic recording.

FIG. 4 is a cross-sectional view illustrating one example of a hard disk according to one embodiment of the present invention.

FIG. 5 is a cross-sectional view illustrating one example of a magnetic tape according to one embodiment of the present invention.

FIG. 6 is a schematic view of a cylinder-on-disk friction testing machine.

FIG. 7 depicts friction test results using the cylinder-on-disk friction testing machine.

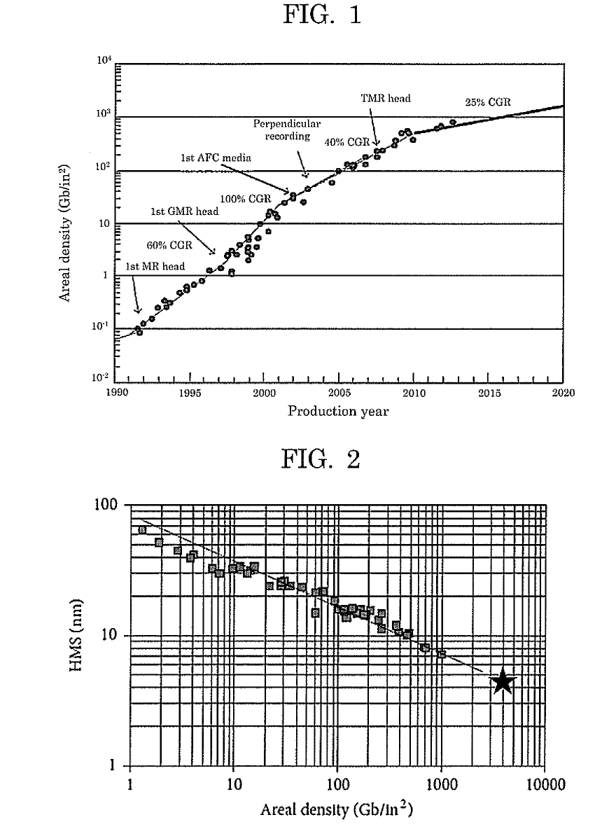

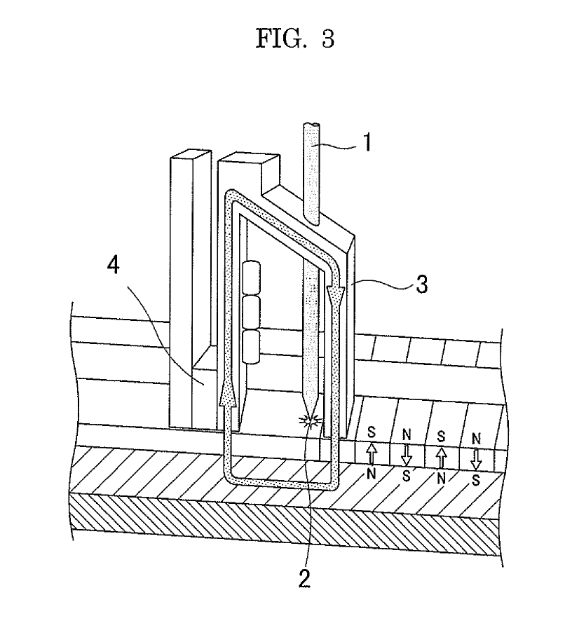

### DESCRIPTION OF THE EMBODIMENTS

Embodiments of the present invention will be explained in details in the order below with reference to drawings, hereinafter.

1. Lubricant and ionic liquid
2. Magnetic recording medium

### 3. Examples

### 1. Lubricant and Ionic Liquid

A lubricant according to one embodiment of the present invention includes an ionic liquid.

An ionic liquid according to one embodiment of the present invention includes a cation that is represented by General Formula (A) below and is free from a fluorine atom, and an anion that is represented by General Formula (X) below and is free from a fluorine atom.

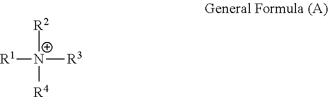

In General Formula (A), R¹ is a group including a straight-chain hydrocarbon group having 6 or more carbon atoms, and R², R³, and R⁴ are each independently a hydrogen atom or a hydrocarbon group.

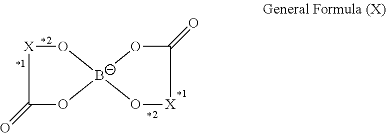

In General Formula (X), X is represented by General Formula (Y-1) below, General Formula (Y-2) below, or General Formula (Y-3) below.

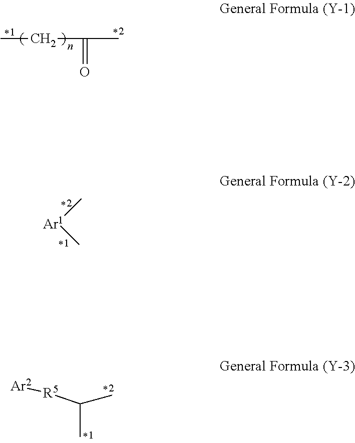

In General Formula (Y-1), n is an integer of from 0 to 5.

In General Formula (Y-2), Ar¹ is an aromatic group that has bond *1 and bond *2 at a meta position and may have a substituent.

In General Formula (Y-3), R⁵ is a bond or an alkylene group and Are is an aromatic group that may have a substituent.

The ionic liquid is free from a fluorine atom. Preferably, the ionic liquid is free from a halogen atom.

The halogen atom includes a fluorine atom, a chlorine atom, a bromine atom, and an iodine atom.

### <<Cation>>

The cation is represented by General Formula (A) below and is free from a fluorine atom.

Preferably, the cation is free from a halogen atom.

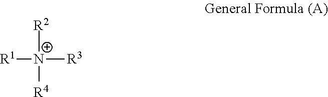

In General Formula (A), R¹ is a group including a straight-chain hydrocarbon group having 6 or more carbon atoms, and R², R³, and R⁴ are each independently a hydrogen atom or a hydrocarbon group.

### <<<R¹>>>

The group including a straight-chain hydrocarbon group having 6 or more carbon atoms is preferably a straight-chain hydrocarbon group having 6 or more carbon atoms.

The presence of a straight-chain hydrocarbon group having 6 or more carbon atoms in General Formula (A) contributes to excellent anti-friction properties of the ionic liquid of the present invention.

The upper limit of the number of carbon atoms of the straight-chain hydrocarbon group having 6 or more carbon atoms is not particularly limited and may be appropriately selected depending on the intended purpose. In view of availability of raw materials, the number of carbon atoms is preferably 30 or less, more preferably 25 or less, and particularly preferably 20 or less. Since the hydrocarbon group has a long chain, a friction coefficient is reduced to improve lubricity.

The hydrocarbon group is not particularly limited as long as the hydrocarbon group is a straight-chain hydrocarbon group. The hydrocarbon group may be a saturated hydrocarbon group, an unsaturated hydrocarbon group having a double bond in part of the hydrocarbon group, or an unsaturated branched hydrocarbon group having a branched chain in part of the hydrocarbon group. Among the above-mentioned examples, the hydrocarbon group is preferably an alkyl group that is a saturated hydrocarbon group in view of abrasion resistance. Moreover, the hydrocarbon group is also preferably a straight-chain hydrocarbon group that does not have a branched chain in any part. Needless to say, the hydrocarbon group may be a hydrocarbon group that may have a branched chain in part of the hydrocarbon group.

<<<R², R³, and R⁴>>>

R², R³, and R⁴ are each independently a hydrogen atom or a hydrocarbon group.

The hydrocarbon group is not particularly limited and may be appropriately selected depending on the intended purpose. The hydrocarbon group is preferably a hydrocarbon group having from 1 to 20 carbon atoms and is more preferably a hydrocarbon group having from 6 to 14 carbon atoms.

The hydrocarbon group may be a saturated hydrocarbon group, an unsaturated hydrocarbon group having a double bond in part of the hydrocarbon group, or an unsaturated branched hydrocarbon group having a branched chain in part of the hydrocarbon group. Among the above-mentioned examples, the hydrocarbon group is preferably an alkyl group (a saturated hydrocarbon group). Moreover, the hydrocarbon group is also preferably a straight-chain hydrocarbon group that does not have a branched chain in any part. Needless to say, the hydrocarbon group may be a hydrocarbon group that may have a branched chain in part of the hydrocarbon group.

In General Formula (A), one of R², R³, and R⁴ is preferably a hydrogen atom because of excellent anti-friction properties.

### <<Anion>>

The anion is represented by General Formula (X) below and is free from a fluorine atom.

Preferably, the anion is free from a halogen atom.

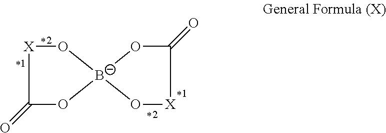

In General Formula (X), X is represented by General Formula (Y-1) below, General Formula (Y-2) below, or General Formula (Y-3) below.

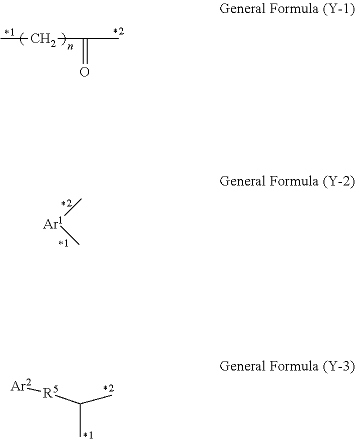

In General Formula (Y-1), n is an integer of from 0 to 5.

In General Formula (Y-2), Ar¹ is an aromatic group that has bond *1 and bond *2 at a meta position and may have a substituent.

In General Formula (Y-3), R⁵ is a bond or an alkylene group and Are is an aromatic group that may have a substituent.

### <<<Ar¹>>>

A substituent of the aromatic group that may have a substituent in Ar² is not particularly limited and may be appropriately selected depending on the intended purpose, as long as the substituent is other than a fluorine atom. Examples of the substituent include a hydrocarbon group. For example, the number of carbon atoms of the hydrocarbon group is from 1 to 4.

The number of substituents of the aromatic group that may have a substituent in Ar¹ is not particularly limited and may be appropriately selected depending on the intended purpose. For example, the number of substituents is from 0 to 5.

Examples of an aromatic group of the aromatic group that may have a substituent in Ar¹ include a phenyl group, a naphthyl group, and an anthracenyl group.

<<<R⁵>>>

The alkylene group in R⁵ is not particularly limited and may be appropriately selected depending on the intended purpose. The alkylene group is preferably an alkylene group having from 1 to 5 carbon atoms.

### <<<Ar²>>>

A substituent of an aromatic group that may have a substituent in Ar² is not particularly limited and may be appropriately selected depending on the intended purpose, as long as the substituent is other than a fluorine atom. Examples of the substituent include a hydrocarbon group. For example, the number of carbon atoms of the hydrocarbon group is from 1 to 4.

The number of substituents of the aromatic group that may have a substituent in Ar² is not particularly limited and may be appropriately selected depending on the intended purpose. For example, the number of substituents is from 0 to 5.

Examples of an aromatic group of the aromatic group that may have a substituent in Ar² include a phenyl group, a naphthyl group, and an anthracenyl group.

Examples of General Formula (X) include structural formulae below.

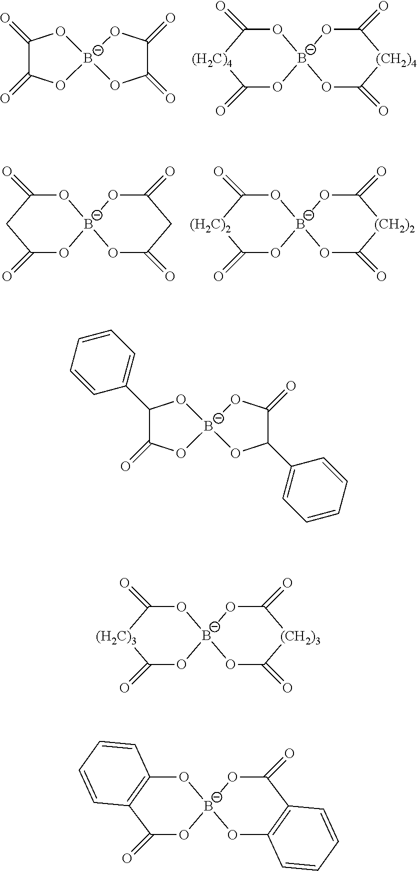

The ionic liquid is preferably an ionic liquid represented by General Formula (1) below or an ionic liquid represented by General Formula (2) below.

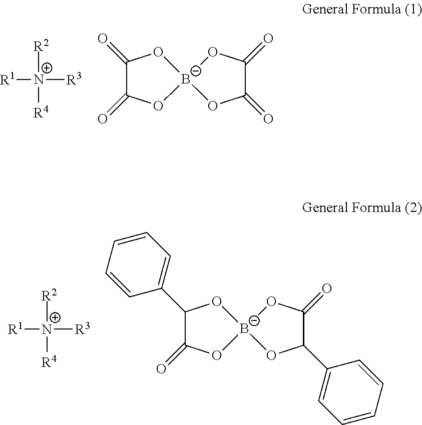

In General Formula (1) and General Formula (2), R¹ is a group including a straight-chain hydrocarbon group having 6 or more carbon atoms, and R², R³, and R⁴ are each independently a hydrogen atom or a hydrocarbon group.

The ionic liquid of the present invention is preferably a liquid at room temperature (25° C.).

A melting point of the ionic liquid is preferably 25° C. or lower, and more preferably 10° C. or lower. The lower limit of the melting point of the ionic liquid is not particularly limited and may be appropriately selected depending on the intended purpose. The melting point of the ionic liquid is preferably −100° C. or higher.

For example, the melting point can be determined by differential scanning calorimetry.

Since the melting point of the ionic liquid is room temperature or lower, the ionic liquid is an ionic liquid having fluidity at room temperature.

A synthesis method of the ionic liquid is not particularly limited and may be appropriately selected depending on the intended purpose. For example, various types of the ionic liquid can be synthesized with reference to a method described in Examples below.

The lubricant in the present embodiment may use the above-described ionic liquid alone, or may be used in combination with a lubricant known in the art. For example, the lubricant can be used in combination with long-chain carboxylic acid, long-chain carboxylic acid ester, perfluoroalkyl carboxylic acid ester, carboxylic acid perfluoroalkyl ester, perfluoroalkyl carboxylic acid perfluoroalkyl ester, a perfluoro polyether derivative, etc.

In order to maintain a lubrication effect under severe conditions, moreover, an extreme-pressure agent may be used in combination at a blending ratio of about 30:70 to about 70:30 based on a mass ratio. The extreme-pressure agent performs a function of preventing friction and wear by reacting with a metal surface as a result of friction heat generated when a metal contact is partially formed in a boundary lubrication region, to form a reaction product coating film. As the extreme-pressure agent, for example, any of a phosphorous-based extreme-pressure agent, a sulfur-based extreme-pressure agent, a halogen-based extreme-pressure agent, an organic metal-based extreme-pressure agent, or a complex-based extreme-pressure agent can be used.

Moreover, an anti-rust agent may be used in combination according to the necessity. The anti-rust agent is not particularly limited as long as the anti-rust agent is an anti-rust agent that can be generally used for this type of a magnetic recording medium. Examples of the anti-rust agent include phenols, naphthols, quinones, heterocyclic compounds including a nitrogen atom, heterocyclic compounds including an oxygen atom, and heterocyclic compounds including a sulfur atom. Moreover, the anti-rust agent may be used by blending with a lubricant. Alternatively, the anti-rust agent may be deposited by dividing into 2 or more layers, for example, by forming a magnetic layer on a non-magnetic support, coating the upper part of the magnetic layer with an anti-rust agent layer, followed by coating with a lubricant layer.

As a solvent of the lubricant, moreover, a single or a combination of solvents, for example, alcohol-based solvents, such as isopropyl alcohol (IPA) and ethanol, can be used. For example, a hydrocarbon-based solvent, such as normal hexane, or a fluorine-based solvent may be used by mixing.

The solvent is preferably a fluorine-based solvent. Examples of the fluorine-based solvent include hydrofluoroethers [e.g., C₃F₇OCH₃, C₄F₉OCH₃, C₄F₉OC₂H₅, C₂F₅CF(OCH₃)C₃F₇, and CF₃(CHF)₂CF₂CF₃]. The hydrofluoroether may be used by mixing with alcohol, such as IPA, ethanol, and methanol.

The fluorine-based solvent may be a commercially available product. Examples of the commercially available product include: Novec™ 7000, 7100, 7200, 7300, and 71IPA, available from 3M; and Vertrel XF, and X-P10 available from Du Pont-Mitsui Fluorochemicals Company, Ltd.

### <2. Magnetic Recording Medium>

Next, a magnetic recording medium using the above-described lubricant will be explained. The magnetic recording medium presented as one embodiment of the present invention includes at least a magnetic layer on or above a non-magnetic support, and the above-described lubricant is deposited on or above the magnetic layer.

The lubricant in the present embodiment can be applied for a so-called a metal thin film magnetic recording medium, in which a magnetic layer is formed on a surface of a non-magnetic support by a method, such as vapor deposition and sputtering. Moreover, the lubricant can be also applied for a magnetic recording medium having a structure where an undercoat layer is disposed between a non-magnetic support and a magnetic layer. Examples of such a magnetic recording medium include magnetic disks and magnetic tapes.

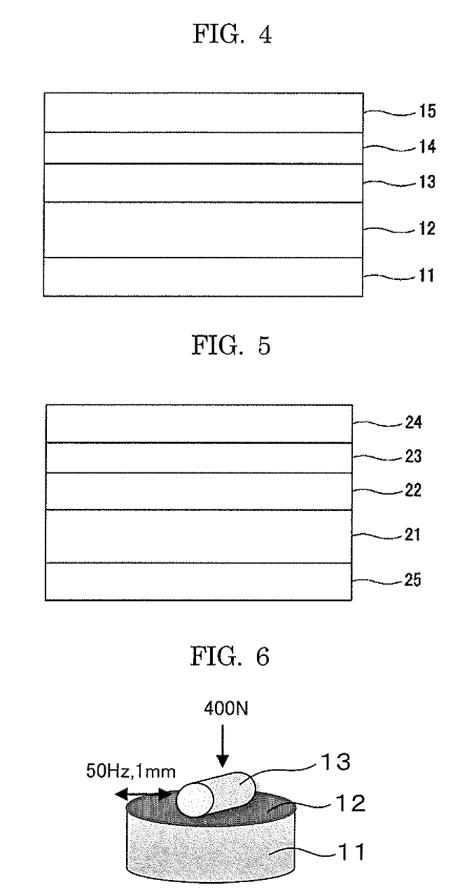

FIG. 4 is a cross-sectional view illustrating one example of a hard disk. The hard disk has a structure where a substrate 11, an undercoat layer 12, a magnetic layer 13, a protective carbon layer 14, and a lubricant layer 15 are sequentially laminated.

Moreover, FIG. 5 is a cross-sectional view illustrating one example of a magnetic tape. The magnetic tape has a structure where a back coat layer 25, a substrate 21, a magnetic layer 22, a protective carbon layer 23, and a lubricant layer 24 are sequentially laminated.

In the magnetic disk illustrated in FIG. 4, the substrate 11 and the undercoat layer 12 are corresponded to a non-magnetic support. In the magnetic tape illustrated in FIG. 5, the substrate 21 is corresponded to a non-magnetic support. When a substrate having rigidity, such as an Al alloy plate and a glass plate, is used as a non-magnetic support, a surface of the substrate may be hardened by forming an oxide film formed by anodizing, or a Ni—P coating on the surface of the substrate.

Each of the magnetic layers 13 and 22 is formed as a continuous film by a method, such as plating, sputtering, vacuum deposition, and plasma CVD. Examples of the magnetic layers 13 and 22 include: longitudinal magnetic recording metal magnetic films formed of metals (e.g., Fe, Co, and Ni), Co—Ni-based alloys, Co—Pt-based alloys, Co—Ni—Pt-based alloys, Fe—Co-based alloys, Fe—Ni-based alloys, Fe—Co—Ni-based alloys, Fe—Ni—B-based alloys, Fe—Co—B-based alloys, or Fe—Co—Ni—B-based alloys; and perpendicular magnetic recording metal magnetic thin films, such as Co—Cr-based alloy thin films, and Co—O-based thin films.

In the case where a longitudinal magnetic recording metal magnetic thin film is formed, particularly, a non-magnetic material, such as Bi, Sb, Pb, Sn, Ga, In, Ge, Si, and Tl, is formed as a base layer 12 on a non-magnetic support in advance, and a metal magnetic material is deposited through vapor deposition or sputtering in a perpendicular direction to diffuse the non-magnetic material into the magnetic metal thin film, to thereby improve a coercive force as well as eliminating orientation to assure in-plane isotropy.

Moreover, a hard protective layer 14 or 23, such as a carbon film, a diamond-formed carbon film, a chromium oxide film, and SiO₂ film, may be formed on a surface of the magnetic layer 13 or 22.

Examples of a method for applying the above-mentioned lubricant to such a metal thin film magnetic recording medium include a method for top-coating a surface of the magnetic layer 13 or 22, or a surface of the protective layer 14 or 23 with the lubricant, as illustrated in FIGS. 4 and 5. A coating amount of the lubricant is preferably from 0.1 mg/m² to 100 mg/m², more preferably from 0.5 mg/m² to 30 mg/m², and particularly preferably from 0.5 mg/m² to 20 mg/m².

As illustrated in FIG. 5, moreover, a metal thin film magnetic tape may optionally have a back coat layer 25, other than a metal magnetic thin film, which is the magnetic layer 22.

The back coat layer 25 is formed by adding a carbon-based powder for imparting conductivity, or an inorganic pigment for controlling a surface roughness to a resin binder, and applying the resin binder mixture. In the present embodiment, the above-described lubricant may be internally added to the back coat layer 25, or applied to a surface of the back coat layer 25 as top coating. Moreover, the above-described lubricant may be internally added to both the magnetic layer 22 and the back coat layer 25, or applied to surfaces of both the magnetic layer 22 and the back coat layer 25 as top coating.

As another embodiment, moreover, the lubricant can be applied for a so-called coating-type magnetic recording medium, in which a magnetic coating film is formed as a magnetic layer by applying a magnetic coating material onto a surface of a non-magnetic support. In the coating-type magnetic recording medium, the non-magnetic support, a magnetic powder constituting the magnetic coating film, and the resin binder for use can be selected from any of those known in the art.

Examples of the non-magnetic support include: polymer supports formed by polymer materials, represented by polyesters, polyolefins, cellulose derivatives, vinyl-based resins, polyimides, polyamides, and polycarbonates; metal substrates formed of aluminium alloys, titanium alloys, etc.; ceramic substrates formed of alumina glass, etc.; and glass substrates. Moreover, a shape of the non-magnetic support is not particularly limited, and may be any form, such as a tape, a sheet, and a drum. Moreover, the non-magnetic support may be subjected to a surface treatment by which fine irregularities are formed, in order to control the surface texture of the non-magnetic support.

Examples of the magnetic powder include: ferromagnetic iron oxide-based particles, such as γ-Fe₂O₃, cobalt-coated γ-Fe₂O₃; ferromagnetic chromium dioxide; ferromagnetic metal-based particles formed of a metal, such as Fe, Co, and Ni, or an alloy containing any of the above-listed metals; and hexagonal ferrite particles in the form of hexagonal plates.

Examples of the resin binder include: polymers of, for example, vinyl chloride, vinyl acetate, vinyl alcohol, vinylidene chloride, acrylic acid ester, methacrylic acid ester, styrene, butadiene, and acrylonitrile; copolymers combining two or more selected from the above-listed ones; polyurethane resins; polyester resins; and epoxy resins. In order to improve dispersibility of the magnetic powder, a hydrophilic polar group, such as a carboxylic acid group, a carboxyl group, and a phosphoric acid group, may be introduced into any of the above-listed binders.

Other than the magnetic powder and the resin binder, additives, such as a dispersing agent, an abrasive, an antistatic agent, and an anti-rust agent, may be added to the magnetic coating film.

As a method for retaining the above-described lubricant in the coating-type magnetic recording medium, there are a method where the lubricant is internally added to the magnetic layer constituting the magnetic coating film formed on the non-magnetic support, a method where the lubricant is applied on a surface of the magnetic layer as top coating, and a combination of the above-listed methods. In the case where the lubricant is internally added into the magnetic coating film, the lubricant is added in an amount of from 0.2 parts by mass to 20 parts by mass relative to 100 parts by mass of the resin binder.

In the case where a surface of the magnetic layer is top-coated with the lubricant, moreover, a coating amount of the lubricant is preferably from 0.1 mg/m² to 100 mg/m², and more preferably from 0.5 mg/m² to 20 mg/m². As a deposition method in the case where the lubricant is applied as top coating, the ionic liquid is dissolved in a solvent, and the obtained solution may be applied or sprayed, or a magnetic recording medium may be dipped in the solution.

The magnetic recording medium, to which the lubricant of the present embodiment is applied, exhibits excellent running performances, abrasion resistance, and durability because of a lubrication effect, and can further improve thermal stability.

Use of the ionic liquid of the present invention is not limited to those described above. For example, the ionic liquid may be used as an additive for various lubricating oils (e.g., lubricating oils for machines and lubricating oils for automobiles). The ionic liquid can be used as various lubricating oils per se.

### EXAMPLES

### 3. Examples

Specific examples of the present invention will be explained hereinafter. In the examples, ionic liquids were synthesized, and lubricants each including the ionic liquid were produced. Each of the lubricants was dissolved in a mixed solvent of n-hexane and ethanol. Each of the lubricant solutions was applied to a surface of a magnetic disk and a surface of a magnetic tape, and disk durability and tape durability were evaluated. Production of a magnetic disk, a durability test of the disk, production of a magnetic tape, and a durability test of the tape were performed in the following manner. Note that, the present invention is not limited to these examples.

### <Production of Magnetic Disk>

A magnetic thin film was formed on a glass substrate to produce a magnetic disk as illustrated in FIG. 4, for example, according to International Publication No. WO2005/068589. Specifically, a chemically reinforced glass disk, which was formed of aluminium silicate glass and had an outer diameter of 65 mm, an inner diameter of 20 mm, and a disk thickness of 0.635 mm, was prepared, and a surface of the glass disk was polished so that Rmax of the surface was to be 4.8 nm, and Ra of the surface was to be 0.43 nm. The glass substrate was subjected to ultrasonic cleaning for 5 minutes each in pure water and in isopropyl alcohol (IPA) having the purity of 99.9% or greater, and the washed glass substrate was left to stand in saturated IPA steam for 1.5 minutes, followed by drying. The resultant glass substrate was provided as a substrate 11.

On the substrate 11, a NiAl alloy (Ni: 50 mol %, Al: 50 mol %) thin film in the thickness of 30 nm as a seed layer, a CrMo alloy (Cr: 80 mol %, Mo: 20 mol %) thin film in the thickness of 8 nm as an undercoat layer 12, and a CoCrPtB alloy (Co: 62 mol %, Cr: 20 mol %, Pt: 12 mol %, B: 6 mol %) thin film in the thickness of 15 nm as a magnetic layer 13 were sequentially formed by DC magnetron sputtering.

Subsequently, a 5 nm-thick protective carbon layer 14 formed of amorphous diamond-like carbon was formed by plasma CVD, and the resultant disk sample was subjected to ultrasonic cleaning for 10 minutes in isopropyl alcohol (IPA) having the purity of 99.9% or greater inside a cleaner to remove impurities on a surface of the disk, followed by drying. Thereafter, a n-hexane/ethanol mixed solution of an ionic liquid was applied on a surface of the disk by dip coating in the environment of 25° C. and 50% in relative humidity (RH), to form about 1 nm of a lubricant layer 15.

### <Thermal Stability Measurement>

A TG/DTA measurement was performed by means of EXSTAR6000 available from Seiko Instruments Inc. at a heating rate of 10° C./min and with a temperature range of from 30° C. to 600° C., while introducing air at a flow rate of 200 mL/min.

### <Disk Durability Test>

A CSS durability test was performed by means of a commercially available strain-gauge-type disk friction-abrasion tester in the following manner. A hard disk was mounted on a rotatable spindle with tightening torque of 14.7 Ncm. Thereafter, a head slider was attached on the hard disk in a manner that a center of an air bearing surface at the inner circumference side of the head slider relative to the hard disk was 17.5 mm from a center of the hard disk. The head used for the measurement was an IBM3370-type inline head, a material of the slider was Al₂ O₃—TiC, and the head load was 63.7 mN. In the test, the maximum value of friction force was monitored per CSS (contact, start, and stop) in the environment of 100 in cleanliness, 25° C., and 60% RH. The number of times when a coefficient of friction was greater than 1.0 was determined as a result of the CSS durability test. When a result of the CSS durability test was greater than 50,000, the result was represented as “>50,000.” Moreover, a CSS durability test was similarly performed after performing a heating test for 3 minutes at a temperature of 300° C., in order to study heat resistance.

### <Production of Magnetic Tape>

A magnetic tape having a cross-sectional structure as illustrated in FIG. 5 was produced. First, Co was deposited on a substrate 21 formed of a 5 μm-thick MICTRON (aromatic polyamide) film available from TORAY INDUSTRIES, INC. by oblique deposition to form a magnetic layer 22 formed of a ferromagnetic metal thin film having a film thickness 100 nm. Next, a carbon protective layer 23 formed of 10 nm-thick diamond-like carbon was formed on a surface of the ferromagnetic metal thin film by plasma CVD, followed by cutting the resultant into a strip having a width of 6 mm. An ionic liquid dissolved in IPA was applied onto the carbon protective layer 23 in a manner that a film thickness of the ionic liquid solution was about 1 nm. In this manner, a lubricant layer 24 is formed to thereby produce a sample tape.

### <Tape Durability Test>

Each sample tape was subjected to a measurement of still durability in an environment having a temperature of −5° C. and in an environment having a temperature of 40° C. and 30% RH, and measurements of a coefficient of friction and shuttle durability in an environment having a temperature of −5° C. and in an environment having a temperature of 40° C. and 90% RH. The still durability was evaluated by a decay time of an output in a paused state decayed by −3 dB. The shuttle resistant was evaluated by the number of shuttles taken until an output was reduced by 3 dB when repeated shuttle run was performed for 2 minutes per time. Moreover, a durability test was similarly performed after performing a heating test for 10 minutes at a temperature of 100° C., in order to study heat resistance.

In the present specification, the measurement of FTIR was performed by means of FT/IR-460 available from JASCO Corporation according to a transmission method using KBr plates or KBr pellets. The resolution of the measurement was 1 cm⁻¹.

The ¹H-NMR and ¹³C-NMR spectra were measured by means of Varian MercuryPlus 300 nuclear magnetic resonance spectrometer (available from Varian, Inc.). A chemical shift of ¹H-NMR was represented with a unit of ppm as a comparison with an internal standard (TMS at 0 ppm or deuterated solvent peak). Splitting patterns were described by denoting a singlet as s, a doublet as d, a triplet as t, a quartet as q, a quintet as quint, a multiplet as m, and a broad peak as br.

### Example 1A

### <Synthesis of Tridodecylammonium Bis(Oxalate)Borate>

Tridodecylammonium bis(oxalate)borate was synthesized according to the following scheme.

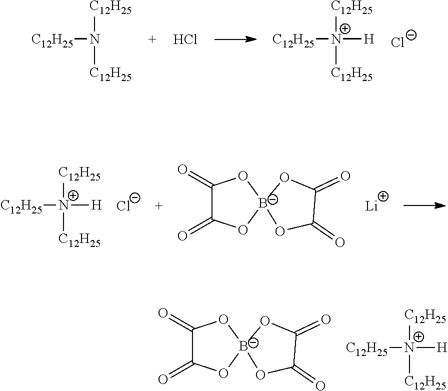

To 49.96 g of tridodecyl amine, an alcohol solution including 11.0 g of concentrated hydrochloric acid was added. After removing the solvent, the resultant was dissolved in dichloromethane, the resultant solution was sufficiently washed with pure water until the washing liquid became neutral. The obtained organic layer was dried with anhydrous sodium sulfate, followed by filtration. After removing dichloromethane of the organic layer, recrystallization was performed with a mixed solvent of n-hexane and ethanol, to thereby obtain 47.6 g of colorless crystals of tridodecylammonium chloride. The yield was 89.0%.

In an ethanol aqueous solution, 15.04 g of tridodecylammonium chloride was dissolved. To the resultant solution, an aqueous solution including 5.25 g of lithium bis(oxalate)borate was added, and the resultant was heated under reflux for 1 hour.

After cooling the resultant, the solvent was removed, and the reaction product was extracted with dichloromethane. The organic layer was sufficiently washed with water, and then was dried with anhydrous sodium sulfate. Thereafter, the solvent was removed to thereby obtain 16.26 g of tridodecylammonium bis(oxalate)borate that was a colorless liquid. The yield was 85.1%.

The FTIR absorption peaks of the generated product are presented below.

The absorption peaks were observed at 988 cm⁻¹, 1,096 cm⁻¹, 1,274 cm⁻¹, 1,468 cm⁻¹, 1,639 cm⁻¹, 1,805 cm⁻¹, 2,854 cm⁻¹, and 2,923 cm⁻¹.

Peaks of a proton (¹H)NMR and a carbon (¹³C)NMR of the obtained compound in CDCl₃ are presented below.

¹H-NMR (CDCl₃, δ ppm); 0.848 (t/J=6.8 Hz, 9H), 1.180-1.340 (m, 54H), 1.630-1.720 (m, 6H), 2.963-3.004 (m, 6H)

¹³C-NMR (CDCl₃, δ ppm); 14.080, 22.647, 23.270, 26.739, 29.048, 29.297, 29.374, 29.450, 29.565, 31.865, 52.420, 159.134

The generated product was determined as tridodecylammonium bis(oxalate)borate from the spectra above.

### Example 2A

### Synthesis of tridodecylammonium bis(mandelate)borate

Tridodecylammonium bis(mandelate)borate was synthesized according to the following scheme.

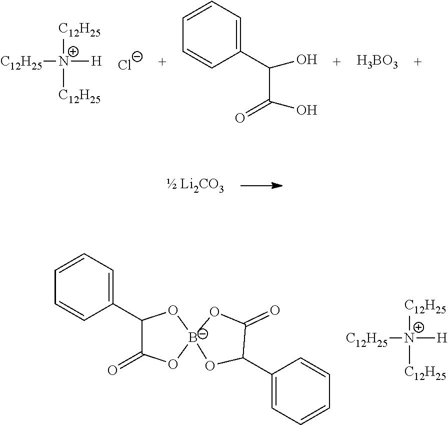

First, 0.370 g of lithium carbonate and 0.622 g of boric acid were dissolved in water. To the resultant aqueous solution, 3.052 g of mandelic acid was added with stirring for 30 minutes. After completing the addition, the resultant mixture was allowed to react for 2 hours at a reaction temperature of 60° C. After returning the reaction solution to room temperature, an ethanol aqueous solution including 5.585 g of the tridodecylammonium chloride synthesized in Example 1A was added, and the resultant mixture was allowed to react overnight. After completing the reaction, the reaction product was extracted with dichloromethane, and the organic layer was sufficiently washed with pure water. After removing the solvent, the resultant was vacuum dried for 20 hours at 100° C., to thereby obtain 7.65 g of tridodecylammonium bis(mandelate)borate of colorless wax at the yield of 96.9%. Note that, the tridodecylammonium bis(mandelate)borate had a plurality of endothermic peaks at 50.0° C. and 79.1° C. and was a liquid at 79.1° C.

The FTIR absorption peaks of the generated product are presented below.

The absorption peaks were observed at 931 cm⁻¹, 1,105 cm⁻¹, 1,259 cm⁻¹, 1,469 cm⁻¹, 1,738 cm⁻¹, 2,853 cm⁻¹, 2,922 cm⁻¹, and 3,032 cm⁻¹.

Peaks of a proton (¹H)NMR and a carbon (¹³C)NMR of the obtained compound in CDCl₃ are presented below.

¹H-NMR (CDCl₃, δ ppm); 0.858 (t/J=6.8 Hz, 9H), 1.140-1.310 (m, 54H), 1.430-1.520 (m, 6H), 2.778-2.820 (m, 6H), 5.310 (s, 1H), 5.397 (d/J=3.6 Hz, 1H), 7.200-7.259 (m, 2H), 7.260-7.351 (m, 4H), 7.574-7.632 (m, 4H)

¹³C-NMR (CDCl₃, δ ppm); 14.099, 22.656, 23.193, 26.489, 28.943, 29.307, 29.422, 29.575, 31.875, 52.526, 126,054, 126.284, 127.520, 127.597, 127.702, 128.162, 128.287, 139.278, 139.374, 178.999, 179.152

The generated product was determined as tridodecylammonium bis(mandelate)borate from the spectra above.

### Example 3A

### Synthesis of trihexyltetradecylammonium bis(oxalate)borate

Trihexyltetradecylammonium bis(oxalate)borate was synthesized according to the following scheme.

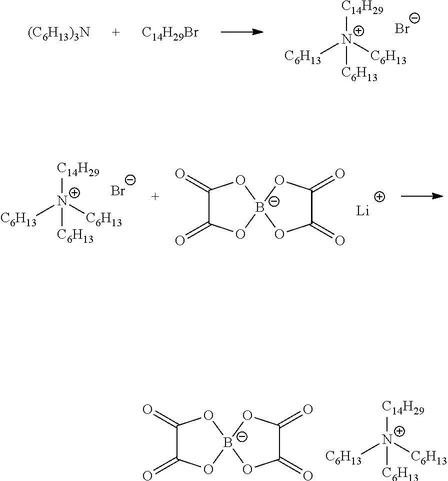

A flask was charged with 14.84 g of trihexylamine and 15.29 g of tetradecyl bromide, and the resultant mixture was allowed to react for 4 hours at 180° C. After completing the reaction, the resultant was cooled, and ethyl acetate was added to the resultant. The soluble component of the resultant solution was removed by decanting. This process was performed 3 times to remove unreacted products. As a result, 28.5 g of a yellowish liquid, trihexyltetradecylammonium was obtained. The yield was 94.5%.

In an ethanol aqueous solution, 8.70 g of the trihexyltetradecylammonium was dissolved. To the resultant solution, an aqueous solution including 3.40 g of lithium bis(oxalate)borate was added. The resultant mixture was heated under reflux for 1 hour, followed by cooling. After completing the reaction, ethanol was removed, and the reaction product was extracted with dichloromethane. The dichloromethane solution was sufficiently washed with pure water until a result of the silver nitrate test became 1.5 negative. The resultant was dried with anhydrous sodium sulfate and the solvent was removed, to thereby obtain 9.10 g of trihexyltetradecylammonium bis(oxalate)borate. The yield was 87.5%.

The FTIR absorption peaks of the generated product are presented below.

The absorption peaks were observed at 988 cm⁻¹, 1,096 cm⁻¹, 1,202 cm⁻¹, 1,275 cm⁻¹, 1,467 cm⁻¹, 1,779 cm⁻¹, 1,804 cm⁻¹, 2,857 cm⁻¹, 2,927 cm, and 2,957 cm⁻¹.

Peaks of a proton (¹H)NMR and a carbon (¹³C)NMR of the obtained compound in CD₃OD are presented below.

¹H-NMR (CD₃OD, δ ppm); 0.818-0.875 (m, 12H), 1.180-1.390 (m, 40H), 1.550-1.690 (m, 8H), 3.172-3.214 (m, 8H)

¹³C-NMR (CD₃OD, δ ppm); 13.764, 14.061, 21.918, 22.283, 22.618, 25.895, 26.221, 28.971, 29.240, 29.278, 29.364, 29.518, 29.565, 29.594, 30.051, 31.846, 58.994, 158.808

The generated product was determined as trihexyltetradecylammonium bis(oxalate)borate from the spectra above.

### Comparative Example 1A

### Synthesis of trihexyltetradecylphosphonium bis(oxalate)borate

For comparison, trihexyltetradecylphosphonium bis(oxalate)borate was synthesized according to the following synthesis scheme in the method disclosed in the non-patent literature (Phys. Chem. Chem. Phys., 2011, 13, 12865-12873).

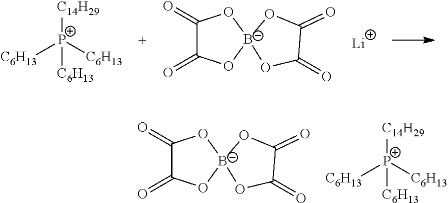

### Comparative Example 2A

### Synthesis of trihexyltetradecylphosphonium bis(mandelate)borate

For comparison, trihexyltetradecylphosphonium bis(mandelate)borate was synthesized according to the following synthesis scheme similarly in the method disclosed in the non-patent literature (Phys. Chem. Chem. Phys., 2011, 13, 12865-12873).

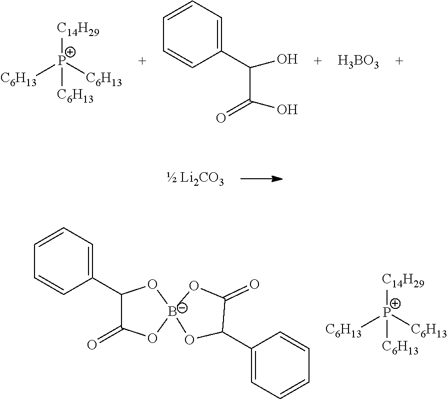

### Comparative Example 3A

### Synthesis of tridodecylammonium bis(trifluoromethanesulfonyl)imide

For comparison, tridodecylammonium bis(trifluoromethanesulfonyl)imide was synthesized according to the following synthesis scheme.

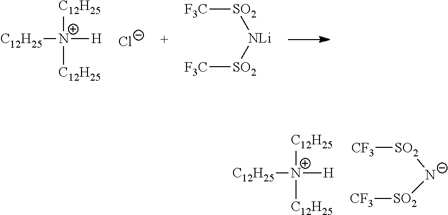

In an ethanol aqueous solution, 8.15 g of the tridecylammonium chloride synthesized in Example 1A was dissolved. To the resulting solution, an aqueous solution including 4.25 g of lithium salt of bis(trifluorosulfonyl)imide was added. The resultant reaction solution was heated under reflux for 1 hour, followed by cooling the solution. After removing the solvent from the solution, the reaction product was extracted with dichloromethane, the organic layer was sufficiently washed with water until a result of the silver nitrate test became negative. The resultant was dried with anhydrous magnesium sulfate, and then the solvent was removed to thereby obtain 11.00 g of tridodecylammonium bis(nonafluorobutanesulfonyl)imide. The yield was 93.9%.

The FTIR absorption peaks of the generated product are presented below.

The absorption peaks were observed at 1,059 cm⁻¹, 1,136 cm⁻¹, 1,189 cm⁻¹, 1,351 cm⁻¹, 1,469 cm⁻¹, 2,853 cm⁻¹, 2,921 cm⁻¹, and 3,156 cm⁻¹.

Peaks of a proton (¹H)NMR and a carbon (¹³C)NMR of the obtained compound in CDCl₃ are presented below.

¹H-NMR (CDCl₃, δ ppm); 0.856 (t/J=6.8 Hz, 9H), 1.190-1.360 (m, 54H), 1.590-1.690 (m, 6H), 3.003-3.046 (rn, 6H)

¹³C-NMR (CDCl₃, δ ppm); 14.080, 22.656, 23.250, 26.441, 28.933, 29.259, 29.288, 29.393, 29.527, 29.556, 31.865, 53.072, 119.620 (q/J=319 Hz)

The generated product was determined as tridodecylammonium bis(trifluoromethanesulfonyl)imide from the spectra above.

The ionic liquids synthesized in Examples and Comparative Examples above are summarized below.

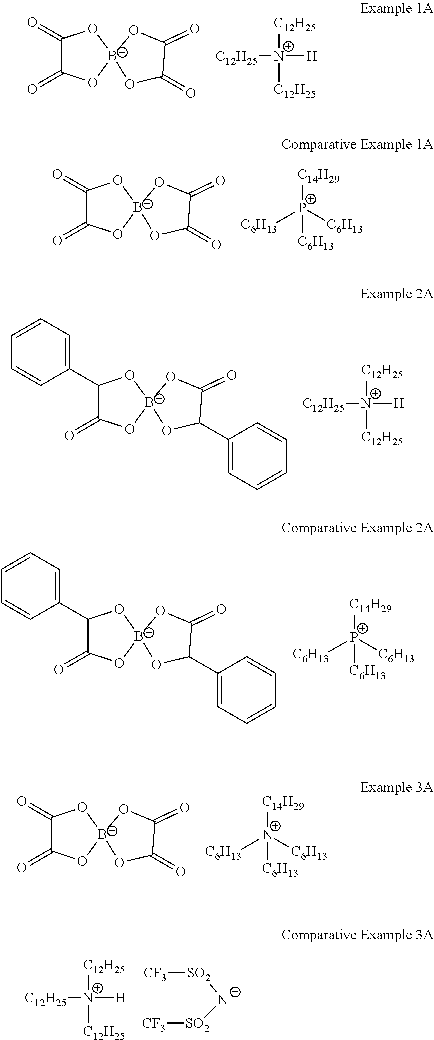

### Example 1B

### <Disk Durability Test>

The tridodecylammonium bis(oxalate)borate that was the lubricant of Example 1A was applied to produce a magnetic disk. As the result of the disk durability test was presented in Table 2, the CSS measurement of the magnetic disk was greater than 50,000 times, and the CSS measurement after the heating test was also greater than 50,000 times, hence excellent durability was exhibited.

### Example 2B

### <Disk Durability Test>

The tridodecylammonium bis(mandelate)borate that was the lubricant of Example 2A was applied to produce a magnetic disk. As the result of the disk durability test was presented in Table 2, the CSS measurement of the magnetic disk was greater than 50,000 times, and the CSS measurement after the heating test was also greater than 50,000 times, hence excellent durability was exhibited.

### Example 3B

### <Disk Durability Test>

The above-described magnetic disk was produced using a lubricant including the trihexyltetradecylammonium bis(oxalate)borate. As presented in Table 2, the CSS measurement of the magnetic disk was 41,000 times that was low compared to the result of Example 1A. Moreover, the CSS measurement after the heating test was 38,000 times. The durability of the magnetic disk was deteriorated as the result of the heating test. The ionic liquid for use was the ammonium bis(oxalate)borate salt including a long-chain alkyl chain, but the durability was low compared to the tertiary ammonium salt of Example 1A.

### Comparative Example 1B

### <Disk Durability Test>

The above-described magnetic disk was produced using a lubricant including the trihexyltetradecylphosphonium bis(oxalate)borate. As presented in Table 2, the CSS measurement of the magnetic disk was 30,000 times that was poor compared to Examples. Moreover, the CSS measurement after the heating test was 25,000 times. The durability of the magnetic disk was deteriorated as the result of the heating test. The ionic liquid for use was the phosphonium bis(oxalate)borate salt including a long-chain alkyl chain, but the durability was low compared to the borate salt of ammonium of Examples.

### Comparative Example 2B

<Disk durability test>

The above-described magnetic disk was produced using a lubricant including the trihexyltetradecylphosphonium bis(mandelate)borate. As presented in Table 2, the CSS measurement of the magnetic disk was 27,000 times that was poor compared to Examples. Moreover, the CSS measurement after the heating test was 24,000 times. The durability of the magnetic disk was deteriorated after the heating test. The ionic liquid for use was the phosphonium bis(mandelate)borate salt including a long-chain alkyl chain, but the durability was low compared to the borate salt of ammonium of Examples. Moreover, the durability was deteriorated compared to the oxalate borate presented in Comparative Example 1B that was also a phosphonium salt.

### Comparative Example 3B

### <Disk Durability Test>

The above-described magnetic disk was produced using a lubricant including the tridodecylammonium bis(trifluoromethanesulfonyl)imide. As the result of the disk durability test was presented in Table 2, the CSS measurement of the magnetic disk was greater than 50,000 times, and the CSS measurement after the heating test was also greater than 50,000 times, hence excellent durability was exhibited. However, the tridodecylammonium bis(trifluoromethanesulfonyl)imide includes a fluorine atom.

### Comparative Example 413

### <Disk Durability Test>

The above-described magnetic disk was produced using a lubricant including Z-DOL. As presented in Table 2, the CSS measurement of the magnetic disk was greater than 50,000 times, but the CSS measurement after the heating test was 12,000 times and the durability was deteriorated further by the heating test.

### Comparative Example 5B

### <Disk Durability Test>

The above-described magnetic disk was produced using a lubricant including the Z-TETRAOL. As presented in Table 2, the CSS measurement of the magnetic disk was greater than 50,000 times, but the CSS measurement after the heating test was 36,000 times and the durability was deteriorated further by the heating test.

The results of Examples 1B to 3B and Comparative Examples 1B to 5B are summarized in Table 2.

When the ionic liquid including a tertiary ammonium having a long-chain alkyl group as a cation and a mandelate borate or oxalate borate anion was used as a lubricant of a magnetic disk, excellent CSS properties were exhibited. The obtained excellent CSS properties were not deteriorated after heating (Example 1B and Example 2B). The above-mentioned ionic liquid exhibited excellent CSS properties compared to a phosphonium salt that was an ionic liquid including the same mandelate borate or oxylate borate anion.

Moreover, the tertiary ammonium salts of Examples 1B and 2B that were each an ammonium salt including an oxalate borate anion had excellent durability compared to the ionic liquid (Example 3B) that was an aprotic quaternary ammonium salt.

Moreover, the ionic liquids of Examples 1B to 3B had the same or slightly less durability compared to the ionic liquid of the bis(trifluoromethylsulfonyl)imide anion (Comparative Example 3B) that had excellent durability. However, the ionic liquid Comparative Example 3A includes a fluorine atom.

Accordingly, it was found that the ionic liquid had excellent CSS durability when the ionic liquid was a borate salt of ammonium having a long-chain alkyl chain.

TABLE 2

| | | | | CSS durability | |
|---|---|---|---|---|---|
| | Compound | CSS durability | | after heating | |
| Ex. 1B | Ex. 1A | 25° C., | >50,000 | 25° C., | >50,000 |
| | | 60% RH | | 60% RH | |
| Ex. 2B | Ex. 2A | 25° C., | >50,000 | 25° C., | >50,000 |
| | | 60% RH | | 60% RH | |
| Ex. 3B | Ex. 3A | 25° C., | 41,000 | 25° C., | 38,000 |
| | | 60% RH | | 60% RH | |
| Comp. | Comp. | 25° C., | 30,000 | 25° C., | 25,000 |
| Ex. 1B | Ex. 1A | 60% RH | | 60% RH | |
| Comp. | Comp. | 25° C., | 27,000 | 25° C., | 24,000 |
| Ex. 2B | Ex. 2A | 60% RH | | 60% RH | |
| Comp. | Comp. | 25° C., | >50,000 | 25° C., | >50,000 |
| Ex. 3B | Ex. 3A | 60% RH | | 60% RH | |
| Comp. | Z-DOL | 25° C., | >50,000 | 25° C., | 12,000 |
| Ex. 4B | | 60% RH | | 60% RH | |
| Comp. | Z-TETRAOL | 25° C., | >50,000 | 25° C., | 36,000 |
| Ex. 5B | | 60% RH | | 60% RH | |

### <Results of Magnetic Tape Durability Test>

Next, the results of durability determined by using the lubricants for magnetic tapes will be described.

### Examples 1C to 3C and Comparative Examples 1C to 5C

The above-described magnetic tapes were each produced by using a lubricant including each of the ionic liquids of Examples 1A to 3A, the ionic liquids of Comparative Examples 1A to 3A, Z-DOL, and Z-TETRAOL. Then, the following measurements were performed.

Coefficient of Friction of Magnetic Tape after Shuttle Run of 100 Times:

In the environment having a temperature of −5° C., or in the environment having a temperature of 40° C. and relative humidity of 90%.

Still Durability Test:

In the environment having a temperature of −5° C., or in the environment having a temperature of 40° C. and relative humidity of 30%.

Shuttle Durability Test:

In the environment having a temperature of −5° C., or in the environment having a temperature of 40° C. and relative humidity of 90%.

Coefficient of Friction of Magnetic Tape after Shuttle Run of 100 Times after Heating Test:

In the environment having a temperature of −5° C., or in the environment having a temperature of 40° C. and relative humidity of 90%.

Still Durability Test after Heating Test:

In the environment having a temperature of −5° C., or in the environment having a temperature of 40° C. and relative humidity of 30%.

Shuttle Durability Test after Heating Test:

In the environment having a temperature of −5° C., or in the environment having a temperature of 40° C. and relative humidity of 90%.

The results of Examples 1C to 3C and Comparative Examples 1C to 5C are summarized in Tables 3-1 and 3-2.

TABLE 3-1

| | | | | | | | Coefficient of | | Still | | Shuttle | |
|---|---|---|---|---|---|---|---|---|---|---|---|---|
| | Coefficient of | | Still | | Shuttle | | friction after | | durability | | durability after | |
| | friction after | | durability/ | | durability/ | | 100 runs after | | after heating/ | | heating/ | |
| | 100 runs | | min | | times | | heating | | min | | times | |
| Ex. 1C | −5° C. | 0.23 | −5° C. | >60 | −5° C. | >200 | −5° C. | 0.23 | −5° C. | >60 | −5° C. | >200 |
| | 40° C., | 0.25 | 40° C., | >60 | 40° C., | >200 | 40° C., | 0.26 | 40° C., | >60 | 40° C., | >200 |
| | 90% RH | | 30% RH | | 90% RH | | 90% RH | | 30% RH | | 90% RH | |
| Ex. 2C | −5° C. | 0.23 | −5° C. | >60 | −5° C. | >200 | −5° C. | 0.24 | −5° C. | >60 | −5° C. | >200 |
| | 40° C., | 0.26 | 40° C., | >60 | 40° C., | >200 | 40° C., | 0.27 | 40° C., | >60 | 40° C., | >200 |
| | 90% RH | | 30% RH | | 90% RH | | 90% RH | | 30% RH | | 90% RH | |
| Ex. 3C | −5° C. | 0.26 | −5° C. | >60 | −5° C. | >200 | −5° C. | 0.28 | −5° C. | >60 | −5° C. | >200 |
| | 40° C., | 0.29 | 40° C., | >60 | 40° C., | >200 | 40° C., | 0. 30 | 40° C., | >60 | 40° C., | >200 |
| | 90% RH | | 30% RH | | 90% RH | | 90% RH | | 30% RH | | 90% RH | |

TABLE 3-2

| | | | | | | | Coefficient of | | Still | | Shuttle | |
|---|---|---|---|---|---|---|---|---|---|---|---|---|
| | Coefficient of | | Still | | Shuttle | | friction after | | durability | | durability after | |
| | friction after | | durability/ | | durability/ | | 100 runs | | after heating/ | | heating/ | |
| | 100 runs | | min | | times | | after heating | | min | | times | |
| Comp. | −5° C. | 0.28 | −5° C. | 29 | −5° C. | 65 | −5° C. | 0.31 | −5° C. | 25 | −5° C. | 55 |
| Ex. 1C | 40° C., | 0.32 | 40° C., | 41 | 40° C., | 120 | 40° C., | 0.34 | 40° C., | 35 | 40° C., | 113 |
| | 90% RH | | 30% RH | | 90% RH | | 90% RH | | 30% RH | | 90% RH | |
| Comp. | −5° C. | 0.31 | −5° C. | 30 | −5° C. | 160 | −5° C. | 0.33 | −5° C. | 26 | −5° C. | 101 |
| Ex. 2C | 40° C., | 0.34 | 40° C., | 40 | 40° C., | 142 | 40° C., | 0.35 | 40° C., | 35 | 40° C., | 115 |
| | 90% RH | | 30% RH | | 90% RH | | 90% RH | | 30% RH | | 90% RH | |
| Comp. | −5° C. | 0.26 | −5° C. | >60 | −5° C. | >200 | −5° C. | 0.27 | −5° C. | >60 | −5° C. | >200 |
| Ex. 3C | 40° C., | 0.28 | 40° C., | >60 | 40° C., | >200 | 40° C., | 0.28 | 40° C., | >60 | 40° C., | >200 |
| | 90% RH | | 30% RH | | 90% RH | | 90% RH | | 30% RH | | 90% RH | |
| Comp. | −5° C. | 0.25 | −5° C. | 12 | −5° C. | 59 | −5° C. | 0.32 | −5° C. | 12 | −5° C. | 46 |
| Ex. 4C | 40° C., | 0.30 | 40° C., | 48 | 40° C., | 124 | 40° C., | 0.35 | 40° C., | 15 | 40° C., | 58 |
| | 90% RH | | 30% RH | | 90% RH | | 90% RH | | 30% RH | | 90% RH | |
| Comp. | −5° C. | 0.22 | −5° C. | 25 | −5° C. | 65 | −5° C. | 0.28 | −5° C. | 23 | −5° C. | 55 |
| Ex. 5C | 40° C., | 0.26 | 40° C., | 35 | 40° C., | 156 | 40° C., | 0.32 | 40° C., | 31 | 40° C., | 126 |
| | 90% RH | | 30% RH | | 90% RH | | 90% RH | | 30% RH | | 90% RH | |

In the tables above, “>60” of the still durability denotes greater than 60 minutes.

In the tables above, “>200” of the shuttle durability denotes greater than 200 times.

The following facts were confirmed.

It was found that the magnetic tapes to which the lubricants including the ionic liquids of Examples 1A to 2A were applied had excellent friction properties, still durability, and shuttle durability.

The magnetic tape to which the lubricant including the ionic liquid of Example 3A was applied had a slightly high coefficient of friction compared to the case where the ionic liquid of Example 1A or Example 2A was used.

The magnetic tape to which the lubricant including the ionic liquid of Comparative Example 1A was applied had a high coefficient of friction compared to the case where the ionic liquid of any of Examples 1A to 3A was used. Moreover, the still durability before and after heating in the environment having a temperature of −5° C. or in the environment having a temperature of 40° C. and relative humidity of 30% was deteriorated compared to the case where the ionic liquid of any of Examples 1A to 3A was used. Furthermore, the shuttle durability before and after heating in the environment having a temperature of −5° C. or in the environment having a temperature of 40° C. and relative humidity of 90% was deteriorated compared to the case where the ionic liquid of any of Examples 1A to 3A was used.

The magnetic tape to which the lubricant including the ionic liquid of Comparative Example 2A was applied also had a high coefficient of friction compared to the case where the ionic liquid of any of Examples 1A to 3A was used. Moreover, the still durability before and after heating in the environment having a temperature of −5° C. or in the environment having a temperature of 40° C. and relative humidity of 30% was deteriorated compared to the case where the ionic liquid of any of Examples 1A to 3A was used. Furthermore, the shuttle durability before and after heating in the environment having a temperature of −5° C. or in the environment having a temperature of 40° C. and relative humidity of 90% was deteriorated compared to the case where the ionic liquid of any of Examples 1A to 3A was used.

It was found that the magnetic tape to which the lubricant including the ionic liquid of Comparative Example 3A had excellent anti-friction properties, still durability and shuttle durability. However, the ionic liquid of Comparative Example 3A includes a fluorine atom.

It was found that the magnetic tape to which Z-DOL was applied had significant deteriorations in still durability and shuttle durability (Comparative Example 4C).

It was found that the magnetic tape to which Z-TETRAOL was applied had significant deteriorations in still durability and shuttle durability (Comparative Example 5C).

It was found from the results presented in Table 3-1 that the ionic liquids of the present invention had excellent anti-friction properties.

Moreover, it was found from the results presented in Table 3-1 that among the ionic liquids of the present invention, the protic ionic liquids could give excellent durability to the magnetic tapes.

### Example 1D

### <Cylinder-On-Disk Friction Test Result>

A friction test was performed by means of a cylinder-on-disk friction tester SRV4 available from Optimol Instruments. A schematic view of the tester is illustrated in FIG. 6.

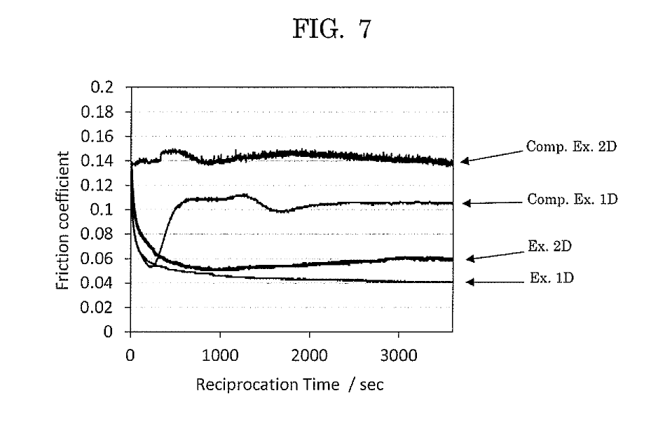

The friction test was performed under the conditions described below. Specifically, 3 g of the ionic liquid lubricant synthesized in Example 1A was applied onto a disk (material: 100Cr6) having a diameter of 25 mm in a temperature environment of 80° C., a load of 400 N (maximum pressure: 0.3 GPa) was applied to a cylinder (material: 100Cr6) having a diameter of 15 mm and a length of 22 mm, and the cylinder was scanned for 60 minutes with a traveling distance of 1.0 mm at a frequency of 50 Hz. A friction was measured during the above-described process. A change in the friction is depicted in FIG. 7. A coefficient of friction after 60 minutes was 0.041.

### [Measuring Conditions]

Frequency: 50 Hz

Motion width: 1.0 mm

Lubricant: 3 mL

Load: 400 N

Maximum pressure: 0.3 GPa

Temperature: 80° C.

Duration: 60 min

### Example 2D

### <Cylinder-On-Disk Friction Test Result>

In the same manner as in Example 1D, 3 g of the ionic liquid lubricant synthesized in Example 2A was applied onto a disk and a friction test was performed. A change in the friction is depicted in FIG. 7. A coefficient of friction after 60 minutes was 0.059.

### Example 3D

### <Cylinder-On-Disk Friction Test Result>

In the same manner as in Example 1D, 3 g of the ionic liquid lubricant synthesized in Example 3A was applied onto a disk and a friction test was performed. A coefficient of friction after 60 minutes was 0.098.

### Comparative Example 1D

### <Cylinder-On-Disk Friction Test Result>

In the same manner as in Example 1D, 3 g of the ionic liquid lubricant synthesized in Comparative Example 1A was applied onto a disk and a friction test was performed. A change in the friction is depicted in FIG. 7. A coefficient of friction after 60 minutes was 0.105.

### Comparative Example 2D

### <Cylinder-On-Disk Friction Test Result>

In the same manner as in Example 1D, 3 g of the ionic liquid lubricant synthesized in Comparative Example 2A was applied onto a disk and a friction test was performed. A change in the friction is depicted in FIG. 7. A coefficient of friction after 60 minutes was 0.140.

### Comparative Example 3D

### <Cylinder-On-Disk Friction Test Result>

In the same manner as in Example 1D, 3 g of the ionic liquid lubricant synthesized in Comparative Example 3A was applied onto a disk and a friction test was performed. A coefficient of friction after 60 minutes was 0.125.

The coefficients of friction after 60 minutes are presented in Table 4 below.

TABLE 4

| | | Coefficient of |
|---|---|---|
| | | friction after 60 |
| Example | Compound | minutes |
| Ex. 1D | Ex. 1A | 0.041 |
| Ex. 2D | Ex. 2A | 0.059 |
| Ex. 3D | Ex. 3A | 0.098 |
| Comp. Ex. 1D | Comp. Ex. 1A | 0.105 |
| Comp. Ex. 2D | Comp. Ex. 2A | 0.140 |
| Comp. Ex. 3D | Comp. Ex. 3A | 0.125 |

From the results depicted in Table 4, the ionic liquids of the present invention exhibited excellent anti-friction properties in the cylinder-on-disk friction test.

Specifically, the coefficients of friction of the tertiary ammonium salts of Example 1A and Example 2A after 60 minutes were respectively 0.041 and 0.059, whereas the coefficients of frictions of the ionic liquids of Comparative Example 1A and Comparative Example 2A, which were the ionic liquids including the same oxalate borate or mandelate borate anion and including a phosphonium salt as a conjugate acid, after 60 minutes were respectively 0.105 and 0.140. In the case of the mandelate borate of Comparative Example 2A, the coefficient of friction was high from the initial stage. In the case of the oxalate borate salt of Comparative Example 1A, the coefficient of friction was low at the initial stage, but the coefficient of friction started to increase about 5 minutes later. In the case of the tertiary ammonium salts of Example 1A and Example 2A, the coefficient of friction was gradually decreased along with the runs, and then stabilized to be almost a constant level. It was assumed that the surface was modified by a tribochemical reaction to improve anti-friction properties.

Among the ammonium salts having the same oxalate borate anion, moreover, the coefficient of friction of the ionic liquid of Example 3A that was an aprotic quaternary ammonium salt was 0.098. The coefficients of friction of Examples 1A and 2A were low compared to the coefficient of friction of Example 3A. In the case of the ionic liquid of Comparative Example 3A that was the tertiary ammonium salt having the same conjugate acid but including bis(trifluoromethylsulfonyl)imide anion as the conjugate base, the coefficient of friction was 0.125 which was higher than Examples. Specifically, it was found that the ionic liquid had a low coefficient of friction in the cylinder-on-disk friction test when the ionic liquid was any of the ionic liquids of Examples above and was a borate salt of ammonium having a long-chain alkyl chain.

### Example 1E

### <Thermal Stability Measurement Results>

The 5% weight reduction temperature, 10% weight reduction temperature, and 20% weight reduction temperature of tridodecylammonium bis(oxalate)borate were 219.9° C., 243.2° C., and 266.1° C., respectively. It was found that the 5% weight reduction temperature, 10% weight reduction temperature, and 20% weight reduction temperature were improved compared to perfluoropolyether Z-DOL (Comparative Example 4E) that was the commercial product known as a lubricant typically used for magnetic recording media and presented as Comparative Example. Moreover, it was found that the 5% weight reduction temperature, 10% weight reduction temperature, and 20% weight reduction temperature were similar to Z-TETRAOL (Comparative Example 5E) that was the commercial product known as a lubricant typically used for magnetic recording media and presented as Comparative Example.

### Example 2E

### <Thermal Stability Measurement Results>

The 5% weight reduction temperature, 10% weight reduction temperature, and 20% weight reduction temperature of tridodecylammonium bis(mandelate)borate were 242.0° C., 268.7° C., and 292.9° C., respectively. It was found that the 5% weight reduction temperature, 10% weight reduction temperature, and 20% weight reduction temperature were improved compared to perfluoropolyether Z-DOL (Comparative Example 4E) that was the commercial product known as a lubricant typically used for magnetic recording media and presented as Comparative Example. Moreover, it was found that the 5% weight reduction temperature, 10% weight reduction temperature, and 20% weight reduction temperature were similar to Z-TETRAOL (Comparative Example 5E) that was the commercial product known as a lubricant typically used for magnetic recording media and presented as Comparative Example.

### Example 3E

### <Thermal Stability Measurement Results>

The 5% weight reduction temperature, 10% weight reduction temperature, and 20% weight reduction temperature of trihexyltetradecylammonium bis(oxalate)borate were 196.9° C., 207.9° C., and 232.5° C., respectively.

### Comparative Example 1E

### <Thermal Stability Measurement Results>

The 5% weight reduction temperature, 10% weight reduction temperature, and 20% weight reduction temperature of trihexyltetradecylphosphonium bis(oxalate)borate were 218.0° C., 233.1° C., and 262.5° C., respectively.

### Comparative Example 2E

### <Thermal Stability Measurement Results>

The 5% weight reduction temperature, 10% weight reduction temperature, and 20% weight reduction temperature of trihexyltetradecylphosphonium bis(mandelate)borate were 289.8° C., 317.5° C., and 341.1° C., respectively.

### Comparative Example 3E

### <Thermal Stability Measurement Results>

The 5% weight reduction temperature, 10% weight reduction temperature, and 20% weight reduction temperature of tridodecylammonium bis(trifluoromethanesulfonyl)imide were 306.2° C., 336.2° C., and 361.8° C., respectively.

### Comparative Example 4E

### <Thermal Stability Measurement Results>

As Comparative Example 4E, measurements of a commercial product, perfluoropolyether Z-DOL that had a hydroxyl group at a terminal and had a molecular weight of about 2,000 were performed. As a result, the 5% weight reduction temperature, 10% weight reduction temperature, and 20% weight reduction temperature of perfluoropolyether Z-DOL were 165.0° C., 197.0° C., and 226.0° C., respectively. The weight reduction was caused by evaporation.

### Comparative Example 5E

### <Thermal Stability Measurement Results>

Perfluoropolyether (Z-TETRAOL) that was a commercial product and was typically used as a lubricant for magnetic recording media was used as a lubricant of Comparative Example 5E. Perfluoropolyether (Z-TETRAOL) had a plurality of hydroxyl groups at terminals and had a molecular weight of about 2,000. The 5% weight reduction temperature, 10% weight reduction temperature, and 20% weight reduction temperature of ZTETRAOL were 240.0° C., 261.0° C., and 282.0° C., respectively. Similarly to Z-DOL, the weight reduction was caused by evaporation.

The results of Examples 1E to 3E and Comparative Examples 1E to 5E are summarized in Table 5.

TABLE 5

| | | 5% weight | 10% weight | 20% weight |
|---|---|---|---|---|
| | | reduction | reduction | reduction |
| | Compound | [° C.] | [° C.] | [° C.] |
| Ex. 1E | Ex. 1A | 219.9 | 243.2 | 266.1 |
| Ex. 2E | Ex. 2A | 242.0 | 268.7 | 292.9 |
| Ex. 3E | Ex. 3A | 196.9 | 207.9 | 232.5 |
| Comp. Ex. 1E | Comp. Ex. 1A | 218.0 | 233.1 | 262.5 |
| Comp. Ex. 2E | Comp. Ex. 2A | 289.8 | 317.5 | 341.1 |
| Comp. Ex. 3E | Comp. Ex. 3A | 306.2 | 336.2 | 361.8 |
| Comp. Ex. 4E | Z-DOL | 165.0 | 197.0 | 226.0 |
| Comp. Ex. 5E | Z-TETRAOL | 240.0 | 261.0 | 282.0 |

It was found from comparison between Example 1E and Example 3E that among the ammonium salts having the same conjugate base, i.e., oxalate borate, the protic ionic liquid (Example 1E) the tertiary ammonium salt had a high heat-resistant temperature compared to an aprotic ionic liquid (Example 3E). Moreover, the protic ionic liquid (Example 1E) that was a tertiary ammonium had a high heat-resistant temperature compared to Comparative Example 1E that was the phosphonium salt having the same conjugate base, i.e., oxalate borate. Moreover, it was found that, among the ionic liquids of the present invention, the protic ionic liquid had the improved heat-resistant temperature compared to Z-DOL that was conventional perfluoropolyether.

Specifically, the ionic liquid of the present invention had excellent heat resistance, and particularly the protic ionic liquid of the present invention enhanced the heat resistance.

As was clear from the descriptions above, the ionic liquid of the present invention exhibited excellent anti-friction properties even through the ionic liquid was free from a fluorine atom. Among the ionic liquids of the present invention, moreover, the protic ionic liquid could maintain excellent lubricity compared to conventional perfluoropolyether, and could maintain lubricity over a long period. Accordingly, a magnetic recording medium using a lubricant including such an ionic liquid can obtain extremely excellent running performances, abrasion resistance, and durability.

Moreover, the ionic liquid of the present invention had the excellent results of the cylinder-on-disk test compared to a phosphate salt using the same anion.

Among the ionic liquids of the present invention, furthermore, the protic ionic liquid had also extremely excellent heat resistance.

What is claimed is:

1. A lubricant comprising:
an ionic liquid,
wherein the ionic liquid includes a cation that is represented by General Formula (A) below and is free from a fluorine atom, and an anion that is represented by General Formula (X) below and is free from a fluorine atom, 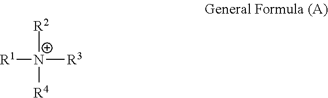
where, in General Formula (A), R¹ is a group including a straight-chain hydrocarbon group having 6 or more carbon atoms, and R², R³, and R⁴ are each independently a hydrogen atom or a hydrocarbon group, 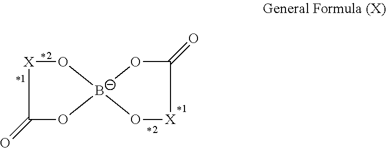
where, in General Formula (X), X is represented by General Formula (Y-1) below, General Formula (Y-2) below, or General Formula (Y-3) below, 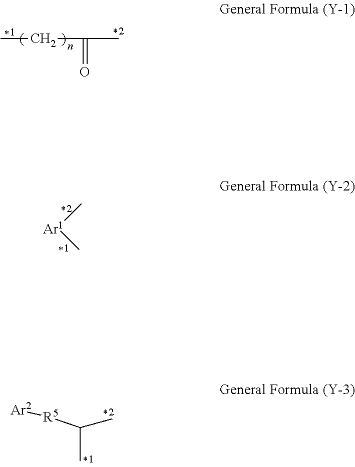
where, General Formula (Y-1), n is an integer of from 0 to 5,
where, General Formula (Y-2), Ar¹ is an aromatic group that has bond *1 and bond *2 at a meta position and may have a substituent, and
where, in General Formula (Y-3), R⁵ is a bond or an alkylene group and Are is an aromatic group that may have a substituent.

2. The lubricant according to claim 1,
wherein in General Formula (A), one of R², R³, and R⁴ is a hydrogen atom.

3. The lubricant according to claim 1,
wherein General Formula (X) is any one of structural formulae below,

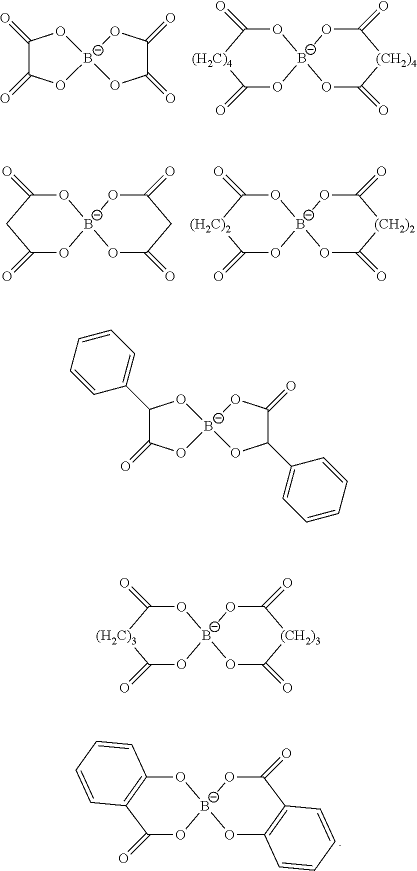

4. A magnetic recording medium comprising:
a non-magnetic support;
a magnetic layer disposed on the non-magnetic support; and
the lubricant according to claim 1 disposed on the magnetic layer.

5. An ionic liquid comprising:
a cation that is represented by General Formula (A) below and is free from a fluorine atom; and
an anion that is represented by General Formula (X) below and is free from a fluorine atom, 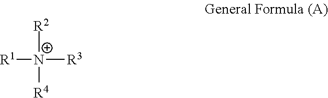
where, in General Formula (A), R¹ is a group including a straight-chain hydrocarbon group having 6 or more carbon atoms, and R², R³, and R⁴ are each independently a hydrogen atom or a hydrocarbon group, 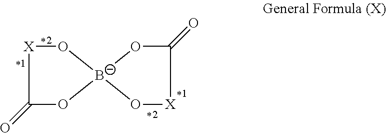
where, in General Formula (X), X is represented by General Formula (Y-1) below, General Formula (Y-2) below, or General Formula (Y-3) below, 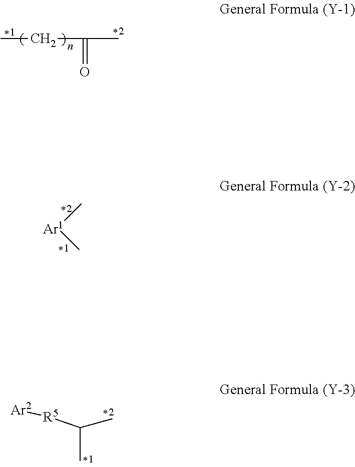
where, General Formula (Y-1), n is an integer of from 0 to 5,
where, General Formula (Y-2), Ar¹ is an aromatic group that has bond *1 and bond *2 at a meta position and may have a substituent, and
where, in General Formula (Y-3), R⁵ is a bond or an alkylene group and Ar² is an aromatic group that may have a substituent.

6. The ionic liquid according to claim 5,
wherein in General Formula (A), one of R², R³, and R⁴ is a hydrogen atom.

7. The ionic liquid according to claim 5,
wherein General Formula (X) is any one of structural formulae below, [chemical structure]
